(19) United States
(12) Patent Application Publication
(10) Pub. No.: US 2002/0103029 A1
(43) Pub. Date: Aug. 1, 2002

(54) Multiplayer gaming

(76) Inventors: Scott Finlayson, New South Wales (AU); Stephen Mulcahy, Dublin (IE); Michael Low, New South Wales (AU)

Correspondence Address: Bradley M. Knepper, SHERIDAN ROSS P.C., Suite 1200, 1560 Broadway, Denver, CO, 80202-5141, US

(21) Appl. No.: 09/859,721

(22) Filed: May 16, 2001

(30) Foreign Application Priority Data
May 17, 2000 (AU) PQ 7597

(51) Int. Cl. G06F 19/00

(52) U.S. Cl. 463/42

(57) ABSTRACT

A method of administration of a live electronic card game in which two or more players wager in a networked environment. The invention relates to the players being assigned virtual cards from a game server, which cards are displayed and used to construct a hand by the players. More specifically the method of the invention comprises the step of assigning to each player, a virtual deck from which their cards are dealt.

### FIELD OF THE INVENTION

The invention pertains to multiplayer networked gaming and more particularly to apparatus and methods for the commercial implementation and administration of multiplayer games by a gaming establishment (“host”) over a network such as the Internet.

### BACKGROUND OF THE INVENTION

The Internet is a non-proprietary network. As such, the reliability of the Internet, over short intervals of time, can not be assured. A game involving numerous remote players may fail for other reasons as well. Means must therefore be devised to administer a situation where a player in a multiplayer networked game, for whatever reason, loses network contact with the host's game server and therefore the other players. In any event, a live multiplayer game for money (or other value) that has become interrupted for an appreciable amount of time may be considered a failure. The amount of interruption that will be tolerated will vary according to factors such as the amount at stake and player expectations. Regardless of the amount of delay, it is in the interest of the host as well as the players that a failed game be resolved. Means are therefore proposed for administering failed games to a point of equitable resolution.

Player fairness and the perceptions of player fairness are of paramount importance to a commercial networked wagering system. Financial fairness to a player requires that if he has taken an irreversible financial risk, then he will have the opportunity to win at odds corresponding to his risk. However, where a player faces one or more human opponents, the player's subjective assessment of the odds of victory may differ from an objective assessment according to factors which are only loosely or not at all related to the mathematical determination of his chances against those opponents.

A player's expectations regarding the way a game is played would be expected to vary according to the extent of player commitment to the game. A player's commitment may be expressed as a sum of a financial commitment in dollars and another commitment in terms of prestige, appearance, status, identity or some other non-financial asset which is at stake during the game. Thus, factors other than money and probability may influence a player's expectations.

Player expectations, apart from expectations of statistical or monetary fairness must be considered because a player whose expectations are not met will not be satisfied as a customer. A dissatisfied player may influence business in a negative way and may be a source of complaints to regulatory agencies, government or the media. Solutions are proposed here for delivering financial fairness to a player.

### OBJECTS AND SUMMARY OF THE INVENTION

It is an object of the invention to provide methods for making live multi-player wagering games more fair.

Accordingly, the invention provides a method of administration of a live electronic card game in which two or more players wager in a networked environment, the players being assigned virtual cards from a game server, which cards are displayed and used to construct a hand by the players, the method comprising the step of assigning to each player, a virtual deck from which their cards are dealt.

The invention also provides, in the administration by a game server of a live networked multiplayer wagering game, a method of resolving an interruption caused by the loss of a player, the method comprising the assigning to a player, a virtual assistant which is adapted to complete a game in which the player is lost, the virtual assistant adapted to act independently once the player is lost.

The invention additionally provides, in the administration of a live networked multi-player wagering game, a method for resolving interrupted games comprising the steps of: detecting the presence of a player that has been lost to a game, then requiring the player to participate in the resolution of that game before the player is allowed to participate in another game.

In preferred embodiments, the invention also provides, in the administration of a networked multi-player wagering game by a game server, which game was once live, then became interrupted due to loss of a player, a method for resolving the game comprising the step of: providing a procedural method, outside of the once live game, for each player to correspond with the game server so that when it is a player's turn to perform an action in furtherance of a game, the state of the game is forwarded to that player and then that player's action is received by the game server and acted on by the game server toward reaching a conclusion to the game.

### BEST MODE AND OTHER EMBODIMENTS OF THE INVENTION

A multiplayer game within the context of this document is defined as a game played by two or more players either (a) against each other, or (b) playing against a house or host where the performance of one player can effect the outcome or experience of another player. A player is “lost” to a game when they can no longer participate in a real time environment. In a single player game, the loss of contact with a server by a player can be administered by restoring the state of the game prior to the disruption at a later point in time. This situation is easily administered because it requires only the cooperation of the lost player. In a multiplayer game, the restoration of the state of the game before a disruption is complicated by the fact that one or more additional players must be co-opted to resume an interrupted game. While this is a desirable outcome, it is not always easy to achieve. In some instances, a player's hardware or software or communications equipment may be disrupted in such a way that resumption oaf the game, in this short term, is not a realistic option. Thus it may be impossible or impracticable to resume the game in a “real time” (live) environment.

The following solution protocols or measures are suggested:

Short Term Resumption

Allow the lost player a relatively short but fair interval (say 15 minutes) to re-establish a network connection which provides him a presence in the game.

Announced to the other players in the interrupted game that a player has been lost.

Invite or demand that the remaining players remain in the game for the short but fair interval to allow the lost player the opportunity to re-establish their presence in the game.

Disallow the last player from participating in other games until they resume the interrupted game, if it is still in progress.

Resumption by Player Invitation

Allow the lost player to post to the other players a time to reconvene which must be unanimously agreed upon. This can be done by “chat”, e-mail, telephone, netmeeting, fax etc. The posting may be mediated by the game host or operator or forwarded by the operator to other players.

The system may have a built-in scheduling function which can be used to make it easier for players to convene for games. When players register they are able to specify times when they are never able to play and preferred playing times. They can maintain this information to specify particular “one-off” unavailabilities or availabilities. Players or the gaming system operator can then invite other players to play at a give time, which can then be accepted or refused with all players then notified accordingly. This then allows players to reconvene at a convenient time for all to finish the game in a single session. The added benefit of this system is the ability to schedule games with friends.

Allow the other players to suggest alternate times to reconvene which must be unanimously agreed upon. This can be accomplished as suggested above.

Resumption by Host Invitation

Allow, encourage or require all players to reconvene at set times, established and communicated by the host e.g. in 24 hours or intervals of 24 hours, or weekly. Player acceptance of this form of periodic invitation to reconvene may be part of “Terms and Conditions” posted to players by the host before a game.

Have the host detect the presence of all players from a failed game on the host's site at a later point in time. If all players from a disrupted game are detected, then encourage each of the players to resume the game by preventing them from playing other games or otherwise participating until the failed game is resolved.

The Host may also suggest times to players, e.g. by e-mail, based on the scheduling system outlined in the “Resumption by player invitation”.

Alternative Procedural Fairness

If all other methods fail, a game can still be resolved or concluded by providing each player with a fair opportunity to participate outside the real time framework.

If fair real time play cannot resume, allow the game to continue by posting (or email or fax etc) to each player a status report and means for making each decision necessary to complete a fair game. This requires providing fair time intervals for each player to make necessary decisions and communicate. This process is repeated until each player has made every decision required for a game to be concluded. This is somewhat analogous to playing chess by mail. This solution It is statistically the most fair, but is time consuming.

The likely method of achieving this is as follows—A player logs on to play, and if it is their turn to make a move in an unfinished game, the current state of the game is presented to them via the game engine. They are then forced to make their move, and then if the player who's turn it is next is not online, they are free to go play a different game. This repeats with each player until all the moves of the current game have been completed. The same procedure can be accomplished by e-mail.

Procedural Safe Guards

Monitor the reasons for and frequency of a player's failure to complete a game in real time and ban any player that abuses the system.

Monitor the playing style of players to detect collusion. Good gambling decision in poker are made by comparing the amount of money the player has committed to a pot, the size of the pot, the amount required to stay in, the number of players still in play and the relative strength of the players hand. Once one has calculated the chance of a player's hand being beaten by another player's hand, one can calculate the return on investment and whether a particular bet is viable. The system would calculate the return on investment, and build up a statistical profile of how far from the optimum certain players play. If a player is constantly dropping out with strong hands, it should raise a flag on the system. The system operator can then review who the suspect player is playing with and review individual games with a view to detecting collusion.

Control monetary betting limits so that player expectations can be controlled.

Notify players (when it is appropriate) that other players may be colluding.

Assign cards to each player from a personal virtual “deck” which is not shared by the other players. The basic concept here is to maintain the integrity of hands for games such as poker while eliminating the ability to determine the cards another player is likely to have by knowing the contents of hands held by collaborators at the same table.

In the case of a game such as draw poker, each players hand would be drawn from their own separate deck. This would ensure that a player couldn't end up with a full hand of jack of hearts for example as might occur in an “infinite” deck. The only trade off is the possibility that two players may have identical hands. This however should not be a major issue. It is already possible, for example, for two players to have a pair of kings and a pair of jacks (of different suits) with an ace high.

For games where there are face up cards, these cards would need to be dealt first from a single deck, then the remaining cards in the deck be copied for use by each player, or alternatively, each face up card is removed from each players personal deck before their hidden cards are dealt.

In some games such as hold 'em and Texas hold 'em certain cards are placed in the centre of the table and shared by each of the players. If each player were allocated an independent deck and the cards in the centre were dealt from an independent deck, then the possibility would exist that a player could have a hand which would be unrealistic or prohibited in a conventional table game using a single deck. More particularly, the problem would be that a player could have a hand which included two identical cards, for example two aces of spades. One would be derived from the players own deck and the second identical card would be derived from the independent centre deck. To avoid this situation, each player's deck has removed from it, those cards which correspond to the shared centre cards in a game. This is done whether or not the shared cards are face up or face down during the game. This operation, when performed by the software could be accompanied by a screen depiction of this process occurring. For example, a representation of a player's deck may be presented in the form of an animation in which either face-up (known) cards or face down (unknown) cards are depicted as being removed from the player's deck. In this way, it is impossible for a player to have or construct a hand in which there are two identical cards, this method still having the advantages of independent decks as discussed above with reference to player collusion.

Cybernetic Solutions for Rapid Resolution

The protocols outlined above provide means whereby a host can assure each player in a multiplayer game that a particular game will always be resolved in a statistically fair manner, However, the host must consider the possibility that player's expectations will be violated because of the player's expectation that a game be resolved, if not in real time, then shortly after the institution of the game. If the possibility exists that a particular game will not be resolved until hours, days, weeks or months after its institution, then a host would be well served by notifying players in that game of that potential This is one way of adjusting a player's expectation. However, a host may also wish to address a player's expectation of a rapid resolution by providing fair or at least mutually agreed means upon which a failed game can be managed until the original game is resumed by the individual players or, resolved quickly.

There are two principle ways in which a lost player may be temporarily replaced for the purpose of resolving or concluding an interrupted game. Both methods require replacing a lost player with a stand-in or virtual assistant of some kind. In the first method, a lost player is replaced by a designated human. This may be a human being nominated by the lost player or nominated by the host. In the second method, a lost player is replaced by a cybernetic, “robotic” or synthetic player (together, a virtual assistant). A virtual assistant may be (a) assigned by the host, (b) selected by a player from a set of two or more acceptable cybernetic players, or (c) be one having attributes which are wholly or in part designed, programmed or selected by a player. All of these robotic cybernetic or synthetic “players” will be referred to as “synthetic”. The term “synthetic” is therefore used to denote a style of cybernetic or non-human representation of a player or opponent that can complete a multiplayer wagering game either for a live human player (at the player's option) or in the place of a lost human player. A synthetic opponent can (a) act independently according to a set of rules or program to simulate a human player (b) act according to a player's instructions or preferences (c) act in accordance with expert training. This last option allows the player to adopt the skills, image, aura or personality of a celebrity player or other known entity. A synthetic player may be a simple algorithm that plays in place of a player or may be more elaborate in terms of its on-screen appearance, “personality” or method of operation.

Even if inherently fair according to legal or statistical analysis, the delayed resolution of an unresolved game may violate a player's expectation that his gain or loss from a risk be determined and reported to him very shortly after the taking of that risk. Unless a player consents in advance to delayed resolution of failed games, this delay potentially represents a violation of a reasonable expectation and in any event, a potential source of customer service, public relations or regulatory difficulties.

As an alternative to the fairest solution, a player might prefer a synthetic opponent stand-in as an expedient solution. It is understood that a human player may prefer to play against one of their existing opponents than any other stand-in. When a player's preferred opponent is lost and can no longer participate, the player may be presented with viable options other than the absolute fairest, which “sub-optimal” solutions may be appealing enough to overcome the sense of disadvantage from the player losing their preferred opponent.

In a failed multi-player game, a player may express a preference for or perceive an advantage against a particular human opponent which that player will not express or perceive as against any other human or stand-in that replaces the human opponent, however fair the replacement.

A player being replaced by a synthetic opponent can trigger a disadvantage, whether real or imagined. One way to overcome that reality or perception is to give each player the opportunity to also deploy a synthetic substitute or “stand-in” of at least potentially equal skill. One solution is for each player to have a synthetic stand-in available to them at all times. If the stand-in could be engaged at any time by any player, then a player could not have the expectation to only play against other humans. One can speculate that the availability to a player of a deployable synthetic stand-in would not always satisfy a player's expectations. This might be true even if the stand-in were every bit as good or better than an opponent. This situation may be managed in several ways.

First it must be remembered that the synthetic player or stand-in can be restricted in its use to be a game “rescue” tool and players may be willing accept its use in extenuating circumstances, such as game failure.

Second, a confident layer is more likely to accept a stand-in opponent, and a novice may accept a stand-in if their hand is either sufficiently winnable or if they have confidence in their own synthetic stand-in. A synthetic stand-in may be configured to provide a player with real time advice or tips without being in control of a player's hand. Further, a player may be willing to relinquish control over their game to their own synthetic stand-in if they have trust in it or have trained it, especially if only used in extenuating circumstances. In some circumstances, the synthetic player will only play from the time a player is “lost” until such time as the player can log back onto the site and resume play.

In order to make a stand-in more attractive, the stand-in may be configurable by the player that it acts for or the player that controls it. A player may be offered certain choices, options or parameters which determine the game playing behaviour or entertainment characteristics of their stand-in. Various configurable features of a stand-in such as the following may be provided:-

Hand rating. Different players may evaluate different hands according to different criteria. A stand-in may be instructed to rate particular hands according to the particular preference of the player that controls it.

Number of players. Just as a player's strategy may change according to the number of players participating in a game, a stand-in may be instructed to similarly alter its behaviour in accordance with the number of players at a table. In many games, the number of players will change over time as active players join or drop out of a game.

Size of pot. The size of the pot may determine whether or not a player is aggressive, passive or defensive. The size of the pot may also determine whether or not a player or his synthetic stand-in will bluff.

Degree of Aggressiveness. Aggressiveness in a card game may be demonstrated by betting or raising toward the pre-established game limit if there is one. Frequent bluffing and bluffing accompanied by high wagering are also expressions of aggressiveness. This parameter may be tailored by player input.

Bluffing frequency. Some players never bluff, other players bluff very frequently. The approximate frequency of bluffing may be determined by a player and input to a synthetic stand-in. The stand-in will there-after abide by the player preference.

In order to maintain fairness and abide by player expectations it is fairly important that if anyone player has a stand-in available to him or her, that all players have stand-ins available to them. It follows that the availability of synthetic players or stand-ins also allow the possibility that a synthetic stand-in or the software to create a stand-in can be sold, bartered for, won in a contest, rented by time or number of games and therefore serves as an item of commerce independent of the gaming software or game itself.

It may be desirable for the system operator to monitor the performance of each stand-in and rate each stand-in. The ratings of each stand-in may be posted to a public forum or document so that players may select from the various publicly available stand-ins. Some stand-ins may be provided by third parties on a cost free basis in exchange for advertising or promotional opportunities. Other stand-ins may carry brands, or the endorsements of personalities or players. Consequently, contests may be arranged between synthetic stand-ins. Contest between synthetic stand-ins provide the opportunity to pit one stand-in against another and determine which performs best under various circumstances. Obviously, the winner of a contest between stand-ins will be more desirable than any of the various losers.

It is entirely realistic that governmental or other regulatory agencies will require the auditing of synthetic stand-in software. Because the synthetic stand-ins participate directly in wagering, regulators will be interested in ensuring that the software complies with various standards associated with player fairness, accountability, robustness, security and privacy. One way to manage the situation is for a provider of stand-in software to provide a configurable stand-in whereby a player or user of that stand-in cannot configure it in ways which are not allowed or contemplated by the provider. In this way, all of the possible configurations of a stand-in are merely subsets of those configurations which are predetermined by the provider. In this way, the provider of the stand-in can have all permutations of the stand-in audited and both the provider and the appropriate regulatory agency can be satisfied that any particular subcombination of attributes selected by a user will be within the approval boundaries of the audit. It may be possible or in fact required that a particular synthetic stand-in be verified before it is introduced into live play. Validating that the source code of the stand-in has not been tampered with would be a quicker procedure than a full-audit of the stand-in functionality and may be fairly quickly performed concurrently with a player entering a live game.

Another way for stand-ins to be audited would be to have a third party stand-ins submitted for approval according to a known standards before it is allowed to participate in live gaming.

It is particularly important that a synthetic stand-in or robotic player which is capable of playing for a player or in place of a player be perceived as fair to other players in the game. In this sense it is important to distinguish a robotic player or stand-in from a “tutor” or “coach” which merely provides a player with advice or tips during the course of play. It is precisely because a player may utilise independent software products which have no connection with the game in progress to perform a coaching or tutoring function that fairness demands a player have access to equally potent software in order to avoid becoming the victim of a collusion between a player and software which is invisible to and undetectable by other players. It will also be desirable to have a synthetic stand-in provide hints or advice to a player during the course of play even when the stand-in is not actually playing in lieu of a player. Hints or coaching from a stand-in may serve several purposes:

To inform a player about the performance of a stand-in under varying circumstances.

Allowing a player to gain confidence in a stand-in.

Giving the player the opportunity to alter the parameters of a stand-in in response to a stand-in's performance or suggestions.

Provide a player with viable tactics where a player is uncertain about which course to pursue.

In a game played with stand-ins, each player will know that the other players also have stand-ins available to them, In such a gaming environment, it may be advantageous to provide on each player's screen, a symbolic or actual representation of the other players in the game. Accordingly, it may be advisable to provide an indication, associated with each player representation, that a player has engaged a stand-in for actual play. Further, it may be advantageous to provide a second indication when a player is taking hints or advice from a stand-in but still executing game options according to their own volition. In the third embodiment, indication is never given as to when a stand-in is actually playing except during the loss of an actual player.

In a fourth embodiment, indication of stand-in participation is never provided. It will be understood that when a player is lost, the synthetic stand-in completes play for that player, that other players are or are not notified of the participation by the stand-in, and that at the conclusion of that game the lost player and his synthetic stand-in may if configured or instructed to do so, exit the game as would a human player exiting a game. Thus, indications about a player's reasons for leaving a game or any data relative to the integrity of a player's hardware or software may remain unknown except to the operators of the site at which the gaming is occurring.

When suddenly faced with a synthetic stand-in opponent, a player has a choice. To continue or exit the game. If they continue, they can continue using their own skill or a synthetic stand-in opponent at their choice.

1. A method of administration of a live electronic card game in which two or more players wager in a networked environment, the players being assigned virtual cards from a game server, which cards are displayed and used to construct a hand by the players, the method comprising the step of:
assigning to each player, a virtual deck from which their cards are dealt.

2. The method of claim 1, wherein:
the electronic card game requires certain shared cards;
each player's virtual deck having virtual cards removed by the game server which correspond to the shared cards.

3. The method of claim 2, wherein:
a player's screen display includes an animation, the animation depicting a deck graphic, the animation further illustrating removal of cards from the deck graphic which suggests the removal of the shared cards from said player's virtual deck.

4. In the administration by a game server of a live networked multi-player wagering game, a method of resolving an interruption caused by the loss of a player, the method comprising:
assigning to a player, a virtual assistant which is adapted to complete a game in which the player is lost,
the virtual assistant adapted to act independently once the player is lost.

5. The method of claim 4, wherein:
the virtual assistant acts, once the player is lost in accordance with instructions received from or parameters dictated by the player prior to the loss of the player.

6. The method of claim 4, wherein:
each player is assigned a virtual assistant which behaves identically.

7. The method of claim 4, wherein:
a player's virtual assistant may be activated by the player before the player is lost.

8. The method of claim 4, wherein:
when a player is lost and the virtual assistant begins to play in place of the lost player, other players are not notified of the event.

9. The method of claim 4, wherein:
when a player is lost and the virtual assistant begins to play in place of the lost player, other players are notified of the event.

10. In the administration of a live networked multi-player wagering game, a method for resolving interrupted games comprising the steps of:
detecting the presence of a player that has been lost to a game, then requiring the player to participate in the resolution of that game before the player is allowed to participate in another game.

11. In the administration of a networked multi-player wagering game by a game server, which game was once live, then became interrupted due to loss of a player, a method for resolving the game comprising the step of:
providing a procedural method, outside of the once live game, for each player to correspond with the game server so that when it is a player's turn to perform an action in furtherance of a game, the state of the game is forwarded to that player and then that player's action is received by the game server and acted on by the game server toward reaching a conclusion to the game.

12. The method of claim 11, wherein:
the procedural method is for the game server to notify players of game status and receive player actions by e-mail or web interface.

13. The method of claim 11, wherein:
the game server will not abide by a player's request to play a new game until the player's action is received.
